(19) United States
(12) Patent Application Publication
(10) Pub. No.: US 2003/0167179 A1
(43) Pub. Date: Sep. 4, 2003

(54) Postage evidence that includes non-visible marks

(76) Inventor: Daniel Lee Briley, Escondido, CA (US)

Correspondence Address: HEWLETT-PACKARD COMPANY, Intellectual Property Administration, P.O. Box 272400, Fort Collins, CO, 80527-2400, US

(21) Appl. No.: 10/086,311

(22) Filed: Mar. 1, 2002

(51) Int. Cl. G06F 17/60

(52) U.S. Cl. 705/1

(57) ABSTRACT

A postage system comprised of a processing system and a printing system is disclosed. The processing system processes postage information to generate a print signal. Examples of postage information include a postage amount, a date, an origination address, a destination address, and security information. The processing system transfers the print signal to the printing system. The printing system prints visible marks on a mail piece responsive to the print signal. The printing system also prints non-visible marks on the mail piece responsive to the print signal. The visible marks and the non-visible marks indicate postage evidence for the mail piece.

### BACKGROUND OF THE INVENTION

1. Field of the Invention

The invention is related to the field of mail systems and postage systems, and in particular, to including non-visible marks in postage evidence of a mail piece.

2. Statement of the Problem

The United States Postal Service (USPS) is one of many delivery services that a person can choose from to deliver a mail piece. The USPS charges a fee for delivering mail pieces and typically requires that a mail piece include evidence of postage before delivering the mail piece. The postage evidence indicates payment for a delivery. The amount of the postage depends on the weight and size of the mail piece, and the type of service used to deliver the mail piece, such as next day delivery, first class mail, certified, etc.

One example of postage evidence is postage stamps. The USPS issues a variety of postage stamps in different denominations. Another example of postage evidence is a metered postage indicia that is printed by postage printing devices. A postage printing device interfaces with a postage meter belonging to the USPS. A customer applies for a postage meter with the USPS, and if approved, the USPS leases the postage meter to the customer. The customer pre-pays for postage on the postage meter. For example, the customer would pre-pay for $250 worth of postage that is programmed onto the postage meter. The customer then buys or leases a postage printing device, which is not supplied by the USPS. Some examples of companies that manufacture postage printing devices are Pitney-Bowes, Ascom, and NeoPost. The customer interfaces the postage meter with the postage printing device to print the metered postage indicia. Each time the postage printing device prints the metered postage indicia, the postage meter decrements against the pre-paid amount.

A customer can also generate postage indicia by logging onto an Internet postage site using a computer, such as www.stamps.com. The customer pays the Internet postage site and receives authorization from the Internet postage site to print postage indicia in exchange for the payment. The customer then prints the postage indicia from his computer using a printer.

Metered postage indicia can include a number of formats when it is printed on an envelope. A common format includes images and text, such as an amount of the postage, a postage meter number, an origination of the mail piece, etc. The metered postage indicia is generally required by the USPS to be printed in a fluorescent red ink in the United States. An example of traditional metered postage indicia is illustrated in FIG. 1. One problem with traditional metered postage indicia is that it can be easily copied. An ink-jet copy machine equipped with fluorescent red ink could be used to copy and mass produce counterfeited metered postage indicia.

To help solve this problem, the USPS has approved an Information Based Indicia Program (IBIP) that uses an Information Based Indicia (IBI) as postage indicia. The IBI is a two-dimensional bar code that allows a customer to incorporate security and mail processing information into the postage indicia. The IBI contains information, such as an amount of the postage, a date, an origination address, a destination address, security encryption information, account information, etc. The IBI also contains the same human readable information as traditional metered postage indicia used today. The IBI helps to avoid postage indicia from being counterfeited because most people visibly cannot decipher what the IBI means. For instance, if an IBI on an envelope contains a certain destination address, then any counterfeited postage copied from the IBI will also contain that destination address. It is feasible that all of the envelopes that include the counterfeited postage will be delivered to the same destination address. The USPS can also view the date of the IBI to determine if the date is suspiciously old.

Unfortunately, postage indicia that includes an IBI can still be copied by conventional copying equipment. Counterfeiters may easily get around the security measures included in the IBI. Plus, the USPS does not scan every IBI today, so there is still opportunity for counterfeit postage indicia to get through the system.

### SUMMARY OF THE SOLUTION

The invention helps solve the above problems with postage evidence that includes non-visible marks. Advantageously, the non-visible marks may not be easily detected by conventional copying equipment. Any counterfeited copies of original postage evidence will not include all of the information contained on the original postage evidence making the counterfeited copies easy to identify. Including the non-visible marks advantageously makes postage evidence harder to counterfeit.

One embodiment of the invention is a postage system comprised of a processing system connected to a printing system. The processing system processes postage information to generate a print signal. Examples of postage information may include a postage amount, a date, an origination address, a destination address, and security information. The processing system transfers the print signal to the printing system. The printing system prints visible marks on a mail piece responsive to the print signal. The printing system also prints non-visible marks on the mail piece responsive to the print signal. The visible marks and the non-visible marks indicate postage evidence for the mail piece.

Another embodiment comprises a mail system comprised of a handling system and a processing system. The handling system receives a mail piece from a sender. The handling system scans postage evidence on the mail piece for visible marks to read visible mark information indicated by the visible marks. The handling system also scans the postage evidence for non-visible marks to read non-visible mark information indicated by the non-visible marks. The handling system may scan the non-visible marks using Ultra Violet (UV), Infrared (IR), or some other light source. The handling system transfers the visible mark information and the non-visible mark information to the processing system. The processing system processes the visible mark information and the non-visible mark information to generate postage information for the mail piece. The postage information may include a postage amount, a date, an origination address, a destination address, and security information for the mail piece. The mail system then delivers the mail piece to a destination based on the postage information.

### BRIEF DESCRIPTION OF THE DRAWINGS

The same reference number represents the same element on all drawings.

FIG. 1 illustrates mail pieces with evidence of postage in the prior art.

FIG. 2 illustrates a postage system in an example of the invention.

FIG. 3 illustrates visible marks and invisible marks making up postage evidence in an example of the invention.

FIG. 4 illustrates a mail system in an example of the invention.

### DETAILED DESCRIPTION OF THE INVENTION

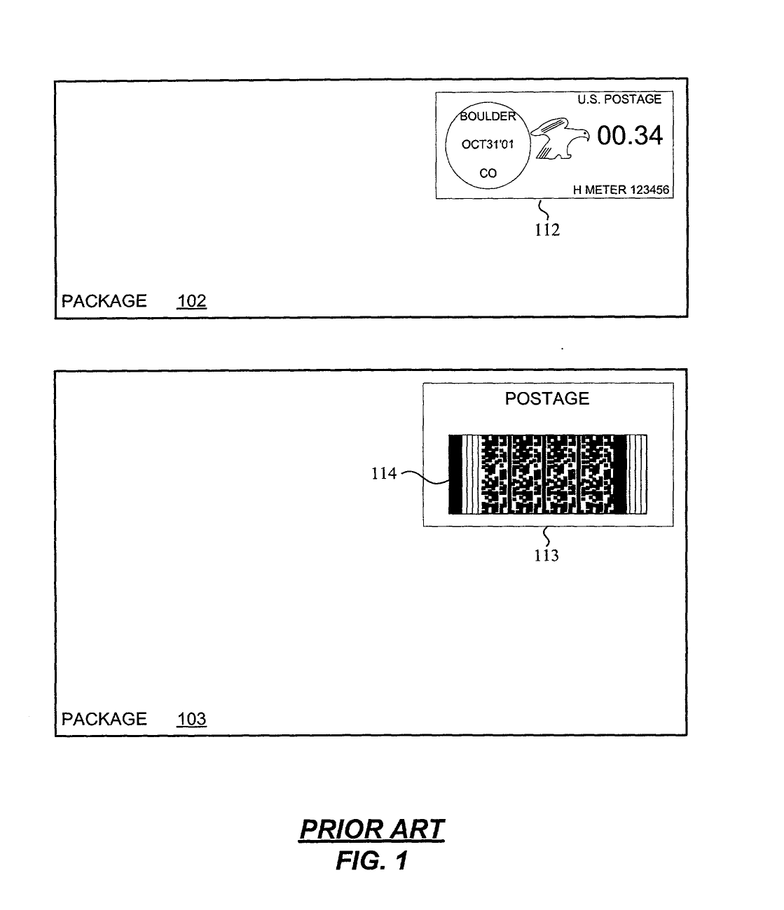

FIGS. 1-4 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Background

FIG. 1 illustrates mail pieces 102-103 in the prior art. Mail pieces 102-103 show two different types of postage indicia recognized by the USPS. Mail piece 102 includes metered postage 112 printed by a typical postage printing device. Metered postage 112 includes an image of an eagle and text that describes the amount of postage, the country issuing the postage, a postage meter number, a city and state of mailing, and a date stamp. Mail piece 103 includes postage indicia 113 that includes an IBI 114 recognized by the USPS. IBI 114 is a two-dimensional bar code that allows a customer to incorporate information such as an amount of the postage, a date, an origination address, and a destination address. Unfortunately, postage indicia 112 and 113 may be easily copied using conventional copying equipment.

Postage System

In the context of the invention, the following definitions may be helpful. Postage evidence includes any indication of payment for a delivery by a delivery service. Postage information includes any information that is related to the delivery of a mail piece. Visible marks include any marks detectable by the human eye. Non-visible marks include any marks not detectable by the human eye. The non-visible marks could be printed with a special type of substance that is only detectable by an Ultra Violet (UV), an Infrared (IR), or some other invisible mark illumination and detection mechanism. A mail piece includes any object or item that can be delivered by a delivery service. A delivery service includes any entity that delivers mail pieces for a fee.

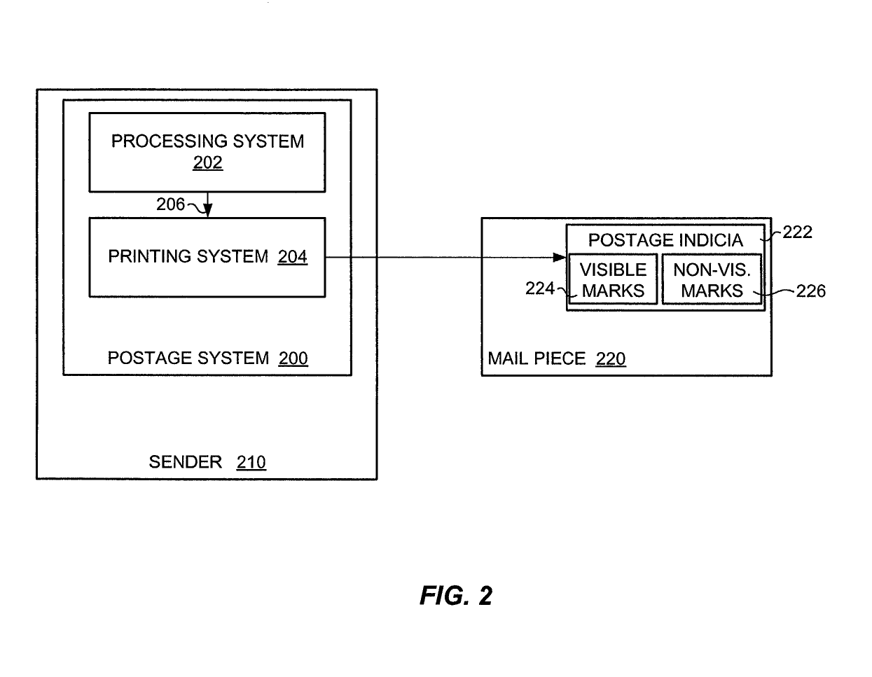

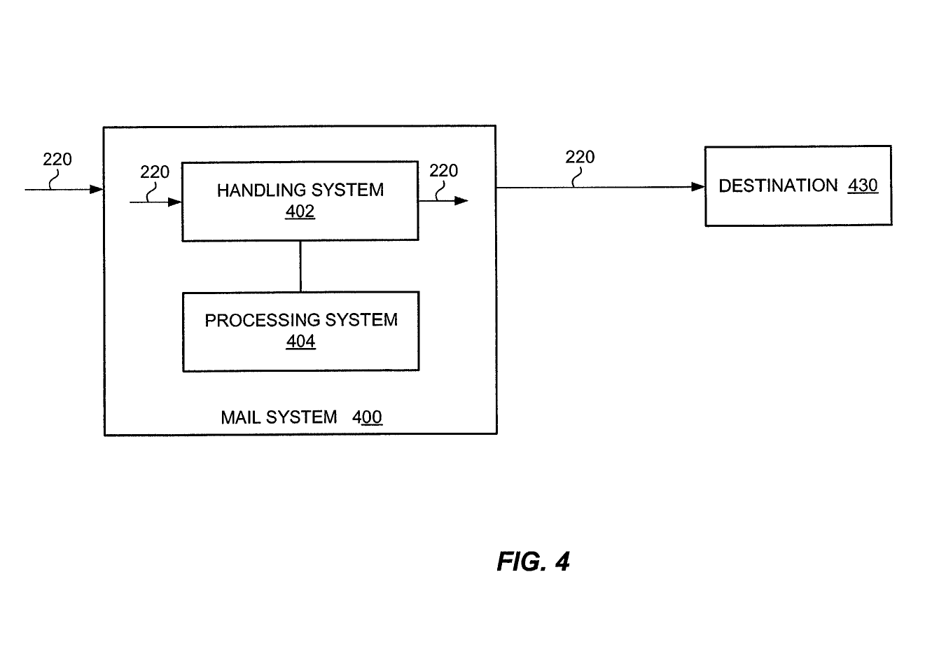

FIG. 2 illustrates postage system 200 in an example of the invention. Postage system 200 is comprised of processing system 202 connected to printing system 204. Examples of printing system 204 include a postage printing device, an inkjet printer, or some other printing mechanism. Postage system 200 is illustrated as being included within sender 210. Assume for this example that sender 210 is sending mail piece 220 to destination 430 in FIG. 4.

In operation, processing system 202 processes postage information to generate print signal 206. Examples of postage information include a postage amount, a date, an origination address, a destination address, security information, or some other information. Processing system 202 could receive the postage information from sender 210 or another source, or determine the postage information in some other manner. For instance, processing system 202 could be connected to a scale and processing system 202 could determine the postage amount based on the weight of mail piece 220. Processing system 202 transfers print signal 206 to printing system 204.

Printing system 204 receives print signal 206. Printing system 204 prints visible marks 224 on mail piece 220 responsive to print signal 206. Printing system 204 prints non-visible marks 226 on mail piece 220 responsive to print signal 206. Visible marks 224 and non-visible marks 226 comprise postage evidence 222 for mail piece 220. Visible marks 224 and non-visible marks 226 may indicate a postage amount, a date, an origination address, a destination address, security information, or some other information. Based on this disclosure, those skilled in the art will appreciate how to modify existing postage systems to make postage system 200.

Postage evidence 222 could comprise metered postage indicia, a postage stamp, PC postage, bulk mailing postage, permit postage, business reply postage, parcel postage, express mail postage, certified mail postage, or any other type of postage.

Visible marks 224 and non-visible marks 226 could be dependent on each other or independent of each other. This is illustrated by the following embodiments.

In one embodiment, visible marks 224 and non-visible marks 226 comprise a bar code. Visible marks 224 and non-visible marks 226 may also comprise an IBI. In either instance, postage evidence 222 may also include text.

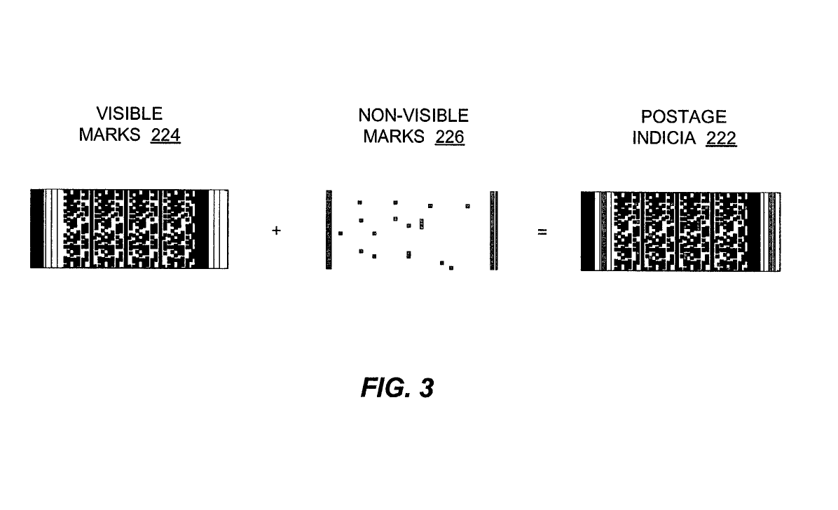

In another embodiment, non-visible marks 226 are used to validate that postage evidence 222 is not a counterfeit. Referring to FIG. 3, for instance, visible marks 224 represent the postage information stored on postage evidence 222, such as the postage amount, the date, the origination address, the destination address, or some other information. Visible marks 224 and non-visible marks 226 are illustrated in FIG. 3 as IBI, but they are not limited to IBI. Information represented by non-visible marks 226 comprises a key to the postage information represented by visible marks 224. Processing system 202 may use a checksum algorithm or other security confirmation to instruct printing system 204 to print non-visible marks 226 in white spaces within visible marks 224. For instance, postage system 200 may key postage evidence 222 with a signature key using non-visible ink in the white space of visible marks 224 as a checksum for visible marks 224.

In another embodiment, postage system 200 may encode a portion of the postage information on visible marks 224 and encode the remaining portion of the postage information on non-visible marks 226. That way, when postage evidence 222 is subsequently read, the postage information cannot be read from postage evidence 222 unless non-visible marks 226 can be read from postage evidence 222.

When printing system 204 prints both visible marks 224 and non-visible marks 226 on postage evidence 222, postage evidence 222 is harder to copy then postage used in the prior art. If postage evidence 222 is scanned with a visible light scanner or copier, the scanner would only see visible marks 224 that the human eye would see. The scanner would not see non-visible marks 226.

After printing system 204 prints postage evidence 222 on mail piece 220, sender 210 delivers mail piece 220 to mail system 400 of FIG. 4.

Mail System—FIG. 4

FIG. 4 illustrates mail system 400 in an example of the invention. Mail system 400 includes handling system 402 connected to processing system 404. Mail system 400 receives mail piece 220 from sender 210 in FIG. 2. Mail system 400 may include additional handling systems that process mail piece 220 before or after handling system 402.

Handling system 402 receives mail piece 220. Handling system 402 scans postage evidence 222 on mail piece 220 for visible marks 224 to read visible mark information indicated by visible marks 224. Handling system 402 also scans postage evidence 222 for non-visible marks 226 to read non-visible mark information indicated by non-visible marks 226. Handling system 402 may scan non-visible marks 226 using Ultra Violet (UV), Infrared (IR), or some other light source. Handling system 402 transfers the visible mark information and the non-visible mark information to processing system 404.

Processing system 404 processes the visible mark information and the non-visible mark information to generate postage information for mail piece 220. The postage information may include a postage amount, a date, an origination address, a destination address, security information, or some other information for mail piece 220. Mail system 400 then delivers mail piece 220 to destination 430 based on the postage information. Based on this disclosure, those skilled in the art will appreciate how to modify existing mail systems to make mail system 400.

In one embodiment, non-visible marks 226 are used to validate that postage evidence 222 is not a counterfeit. For instance, processing system 404 first processes the visible mark information to obtain the postage information, such as the postage amount, the date, the origination address, and the destination address. Processing system 404 then processes the non-visible mark information to validate the postage information. The non-visible mark information could comprise a key to the visible mark information. Processing system 404 may use a checksum or other security confirmation algorithm to process the visible mark information and the non-visible mark information. The results of the checksum algorithm will indicate whether postage evidence 222 is valid.

In another embodiment, a portion of the postage information could be encoded on visible marks 224 and the remaining portion of the postage information could be encoded on non-visible marks 226. That way, the postage information cannot be read from postage evidence 222 unless non-visible marks 226 can be read from postage evidence 222.

1. A mail system configured to process postage evidence on a mail piece, the mail system comprising:
a handling system configured to receive the mail piece, scan the postage evidence for visible marks and non-visible marks to read visible mark information indicated by the visible marks and non-visible mark information indicated by the non-visible marks, and transfer the visible mark information and the non-visible mark information; and
a processing system coupled to the handling system and configured to process the visible mark information and the non-visible mark information to generate postage information for the mail piece.

2. The mail system of claim 1 wherein the handling system is further configured to scan the non-visible marks using an Ultra Violet (UV) light.

3. The mail system of claim 1 wherein the handling system is further configured to scan the non-visible marks using an Infrared (IR) light.

4. The mail system of claim 1 wherein the processing system is further configured to process the non-visible mark information to validate the postage evidence.

5. The mail system of claim 4 wherein the non-visible mark information comprises a key to the visible mark information.

6. The mail system of claim 1 wherein the processing system is further configured to process the non-visible mark information and the visible mark information using a checksum algorithm.

7. The mail system of claim 1 wherein the visible marks and the non-visible marks comprise a bar code.

8. The mail system of claim 7 wherein the visible marks and the non-visible marks comprise Information Based Indicia (IBI).

9. The mail system of claim 1 wherein the postage information includes a postage amount.

10. The mail system of claim 9 wherein the postage information includes a date, an origination address, a destination address, and security information.

11. A method for processing postage evidence on a mail piece, the method comprising:
receiving the mail piece;
scanning the postage evidence for visible marks and non-visible marks to read visible mark information indicated by the visible marks and non-visible mark information indicated by the non-visible marks; and
processing the visible mark information and the non-visible mark information to generate postage information for the mail piece.

12. The method of claim 11 further comprising scanning the non-visible marks using an Ultra Violet (UV) light.

13. The method of claim 11 further comprising scanning the non-visible marks using an Infrared (IR) light.

14. The method of claim 11 further comprising processing the non-visible mark information to validate the postage evidence.

15. The method of claim 14 wherein the non-visible mark information comprises a key to the visible mark information.

16. The method of claim 11 further comprising processing the non-visible mark information and the visible mark information using a checksum algorithm.

17. The method of claim 11 wherein the visible marks and the non-visible marks comprise a bar code.

18. The method of claim 17 wherein the visible marks and the non-visible marks comprise Information Based Indicia (IBI).

19. The method of claim 11 wherein the postage information includes a postage amount.

20. The method of claim 19 wherein the postage information includes a date, an origination address, a destination address, and security information.

21. A postage system configured to print postage evidence on a mail piece, the postage system comprising:
a processing system configured to process postage information to generate a print signal and transfer the print signal; and
a printing system configured to receive the print signal, print visible marks on the mail piece responsive to the print signal, and print non-visible marks on the mail piece responsive to the print signal, wherein the visible marks and the non-visible marks indicate the postage evidence for the mail piece.

22. The postage system of claim 21 wherein the non-visible marks indicate a validity of the postage evidence.

23. The postage system of claim 22 wherein information represented by the non-visible marks comprises a key to information represented by the visible marks.

24. The postage system of claim 21 wherein the processing system is further configured to generate the print signal using a checksum algorithm to instruct the printing system to print the non-visible marks and the visible marks.

25. The postage system of claim 21 wherein the visible marks and the non-visible marks comprise a bar code.

26. The postage system of claim 25 wherein the visible marks and the non-visible marks comprise Information Based Indicia (IBI).

27. The postage system of claim 21 wherein the visible marks and the non-visible marks indicate a postage amount.

28. The postage system of claim 27 wherein the visible marks and the non-visible marks indicate a date, an origination address, a destination address, and security information.

29. A method for operating a postage system for printing postage evidence on a mail piece, the method comprising:
printing visible marks on the mail piece; and
printing non-visible marks on the mail piece, wherein the visible marks and the non-visible marks indicate the postage evidence for the mail piece.

30. The method of claim 29 wherein the non-visible marks indicate a validity of the postage evidence.

31. The method of claim 30 wherein information represented by the non-visible marks comprises a key to information represented by the visible marks.

32. The method of claim 29 further comprising printing the non-visible marks and the visible marks based on a checksum algorithm.

33. The method of claim 29 wherein the visible marks and the non-visible marks comprise a bar code.

34. The method of claim 33 wherein the visible marks and the non-visible marks comprise Information Based Indicia (IBI).

35. The method of claim 29 wherein the visible marks and the non-visible marks indicate a postage amount.

36. The method of claim 35 wherein the visible marks and the non-visible marks indicate a date, an origination address, a destination address, and security information.

37. A postage system configured to print postage evidence on a mail piece, the postage system comprising:
a processing system configured to process postage information to generate a print signal and transfer the print signal; and
a printing system configured to receive the print signal, print a visible bar code on the mail piece responsive to the print signal, and print a non-visible bar code on the mail piece within white space on the visible bar code responsive to the print signal, wherein the visible bar code and the non-visible bar code indicate the postage evidence for the mail piece.

38. The postage system of claim 37 wherein the non-visible bar code indicates a validity of the postage evidence.

39. The postage system of claim 37 wherein the processing system is further configured to generate the print signal using a checksum algorithm to instruct the printing system to print the non-visible bar code and the visible bar code.

40. The postage system of claim 37 wherein the visible bar code and the non-visible bar code comprise Information Based Indicia (IBI).

41. A method for operating a postage system for printing postage evidence on a mail piece, the method comprising:
printing a visible bar code on the mail piece; and
printing a non-visible bar code on the mail piece within white space on the visible bar code, wherein the visible bar code and the non-visible bar code indicate the postage evidence for the mail piece.

42. The method of claim 41 wherein the non-visible bar code indicates a validity of the postage evidence.

43. The method of claim 41 further comprising printing the non-visible bar code and the visible bar code based on a checksum algorithm.

44. The method of claim 41 wherein the visible bar code and the non-visible bar code comprise Information Based Indicia (IBI).
